(19) United States
(12) Patent Application Publication
(10) Pub. No.: US 2024/0087299 A1
(43) Pub. Date: Mar. 14, 2024

(54) IMAGE PROCESSING APPARATUS, IMAGE PROCESSING METHOD, AND IMAGE PROCESSING COMPUTER PROGRAM PRODUCT

(71) Applicant: KABUSHIKI KAISHA TOSHIBA, Tokyo (JP)

(72) Inventors: Hiroo SAITO, Kawasaki (JP); Tomoyuki SHIBATA, Kawasaki (JP)

(73) Assignee: KABUSHIKI KAISHA TOSHIBA, Tokyo (JP)

(21) Appl. No.: 18/169,281

(22) Filed: Feb. 15, 2023

(30) Foreign Application Priority Data
Sep. 9, 2022 (JP) 2022-143745

(51) Int. Cl. G06V 10/774; G06V 10/82; G06V 20/70

(52) U.S. Cl. CPC G06V 10/7753; G06V 10/82; G06V 20/70

(57) ABSTRACT

According to one embodiment, an image processing apparatus 1 includes one or more hardware processors configured to function as an acquisition unit 20A, a pseudo label estimation unit 20B, and a learning unit 20C. The acquisition unit 20A acquires unlabeled training data including an image to which a correct label of an attribute is unassigned. The pseudo-label estimation unit 20B estimates a pseudo-label, which is an estimation result of the attribute of the image of the unlabeled training data, based on an identification target region according to a type of the attribute to be identified by a first learning model 30 to be learned in the image of the unlabeled training data. The learning unit 20C learns the first learning model 30 identifying the attribute of the image by using first labeled training data with the pseudo-label being assigned to the image of the unlabeled training data.

### CROSS-REFERENCE TO RELATED APPLICATIONS

This application is based upon and claims the benefit of priority from Japanese Patent Application No. 2022-143745, filed on Sep. 9, 2022; the entire contents of which are incorporated herein by reference.

### FIELD

Embodiments described herein relate generally to an image processing apparatus, an image processing method, and an image processing computer program product.

### BACKGROUND

Disclosed is a technique of learning a learning model for identifying an attribute of an image. For example, disclosed is a technique related to learning using labeled training data including an image to which a correct label of an attribute is assigned and unlabeled training data including an image to which the correct label of the attribute is not assigned. As a technique using the unlabeled training data, disclosed is a technique of performing learning while estimating an attribute of an image included in the unlabeled training data. In a case where the attribute of the image included in the unlabeled training data is estimated during learning, a technique of estimating and learning the attribute from the same identification target region as a learning model to be learned is used.

However, depending on the image included in the unlabeled training data, it may be difficult to estimate the attribute from the same identification target region as the learning model to be learned. For this reason, in the related art, the attribute of the image of the unlabeled training data cannot be estimated, and as a result, identification accuracy of the learning model may deteriorate.

### BRIEF DESCRIPTION OF THE DRAWINGS

FIG. 1 is a schematic diagram of an image processing system;

FIG. 2 is a schematic diagram of training data;

FIG. 3A is a schematic diagram of an image;

FIG. 3B is a schematic diagram of an image;

FIG. 4 is an explanatory diagram of pseudo label estimation processing;

FIG. 5 is an explanatory diagram of skeleton detection processing;

FIG. 6A is an explanatory diagram of learning;

FIG. 6B is an explanatory diagram of learning;

FIG. 7 is a flowchart of a flow of information processing;

FIG. 8 is an explanatory diagram of pseudo label estimation processing;

FIG. 9 is a flowchart of a flow of information processing; and

FIG. 10 is a hardware configuration diagram.

### DETAILED DESCRIPTION

An image processing apparatus according to an embodiment includes one or more hardware processors configured to function as an acquisition unit, a pseudo label estimation unit, and a learning unit. The acquisition unit is configured to acquire unlabeled training data including an image to which a correct label of an attribute is not assigned. The pseudo label estimation unit is configured to estimate a pseudo label, which is an estimation result of the attribute of the image of the unlabeled training data, based on an identification target region according to a type of the attribute to be identified by a first learning model to be learned in the image of the unlabeled training data. The learning unit is configured to learn the first learning model that identifies the attribute of the image using first labeled training data for which the pseudo label is assigned to the image of the unlabeled training data.

An object of the embodiments herein is to provide an image processing apparatus, an image processing method, and an image processing computer program product, configured to be able to provide a learning model capable of identifying an attribute of an image with high accuracy.

Hereinafter, an image processing apparatus, an image processing method, and an image processing computer program product according to the embodiments will be described in detail with reference to the accompanying drawings.

### First Embodiment

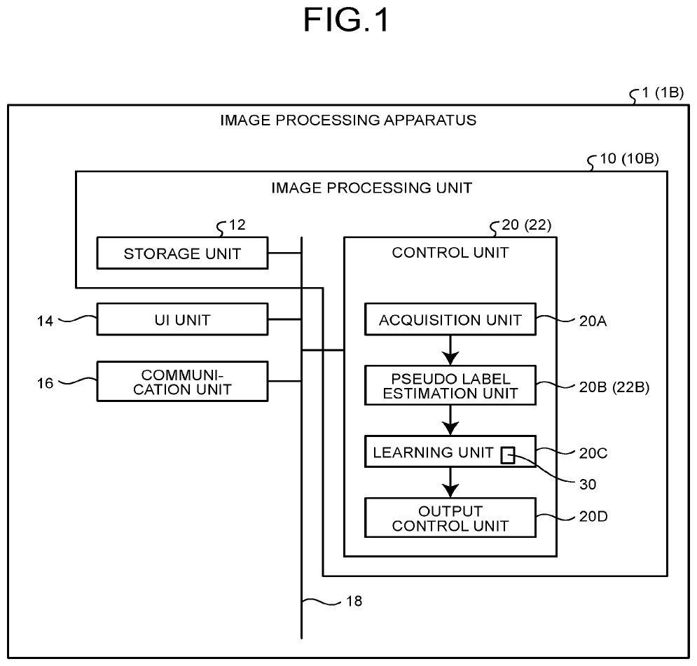

FIG. 1 is a schematic diagram of an example of an image processing apparatus 1 according to the present embodiment.

The image processing apparatus 1 includes an image processing unit 10, a user interface (UI) unit 14, and a communication unit 16. The image processing unit 10, the UI unit 14, and the communication unit 16 are communicably connected to each other via a bus 18 or the like.

The UI unit 14 may be configured to be communicably connected to the image processing unit 10 in a wired or wireless manner. The UI unit 14 and the image processing unit 10 may be connected to each other via a network or the like.

The UI unit 14 has a display function of displaying various types of information and an input function of receiving an operation input by a user. The display function is, for example, a display, a projection device, or the like. The input function is, for example, a pointing device such as a mouse and a touch pad, a keyboard, or the like. A touch panel having a display function and an input function formed to be integrated with each other may be used.

The communication unit 16 is a communication interface configured to communicate with an external information processing device or the like outside the image processing apparatus 1.

The image processing apparatus 1 is an information processing device that learns a first learning model 30. The first learning model 30 is a learning model to be learned by the image processing apparatus 1. The first learning model 30 is a neural network model for identifying an attribute of an image. The attribute is information indicating properties and characteristics of the image. The first learning model 30 is, for example, a deep neural network (DNN) model obtained by deep learning.

The image processing unit 10 of the image processing apparatus 1 includes a storage unit 12 and a control unit 20. The storage unit 12 and the control unit 20 are communicably connected to each other via the bus 18 or the like.

The storage unit 12 stores various types of data. The storage unit 12 may be provided outside the image processing unit 10. Furthermore, at least one of one or a plurality of functional units included in the storage unit 12 and the control unit 20 may be configured to be mounted on the external information processing device communicably connected to the image processing apparatus 1 via a network or the like.

The control unit 20 executes information processing in the image processing unit 10. The control unit 20 includes an acquisition unit 20A, a pseudo label estimation unit 20B, a learning unit 20C, and an output control unit 20D.

The acquisition unit 20A, the pseudo label estimation unit 20B, the learning unit 20C, and the output control unit 20D are implemented by, for example, one or a plurality of processors. For example, each of the above-described units may be implemented by causing a processor such as a central processing unit (CPU) to execute a program, that is, by software. Each of the units may be implemented by a processor such as a dedicated IC or a circuit, that is, by hardware. Each of the units may be implemented by using software and hardware in combination. In the case of using a plurality of processors, each processor may implement one of the respective units, or may implement two or more of the respective units.

The acquisition unit 20A acquires training data. The training data is data used at the time of learning of the first learning model 30.

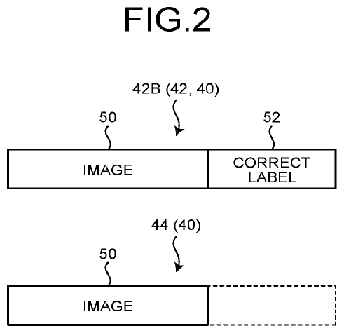

FIG. 2 is a schematic diagram of an example of training data 40. The training data 40 includes at least one of labeled training data 42 and unlabeled training data 44.

The labeled training data 42 is data including an image 50 to which a correct label 52 is assigned. The correct label 52 is a label indicating an attribute of the image 50. That is, the labeled training data 42 is data including a pair of the image 50 and the correct label 52 indicating the attribute of the image 50.

The unlabeled training data 44 is data including the image 50 to which the correct label 52 is not assigned. In other words, the unlabeled training data 44 is data including the image 50.

The acquisition unit 20A acquires second labeled training data 42B and the unlabeled training data 44. The second labeled training data 42B is an example of the labeled training data 42, and is the labeled training data 42 acquired by the acquisition unit 20A.

It is noted that the acquisition unit 20A may acquire at least the unlabeled training data 44 as the training data 40. In the present embodiment, a description will be given, as an example, as to a mode in which the acquisition unit 20A acquires the unlabeled training data 44 and the second labeled training data 42B as the training data 40.

Referring back to FIG. 1, the description will be continued.

The acquisition unit 20A acquires the unlabeled training data 44 and the second labeled training data 42B included in the training data 40 by reading the training data 40 from the storage unit 12. Furthermore, the acquisition unit 20A may acquire the unlabeled training data 44 and the second labeled training data 42B included in the training data 40 by receiving the training data 40 from the external information processing device or the like via the communication unit 16. Furthermore, the acquisition unit 20A may acquire the unlabeled training data 44 and the second labeled training data 42B included in the training data 40 by receiving the training data 40 input or selected by an operation instruction of the UI unit 14 by a user.

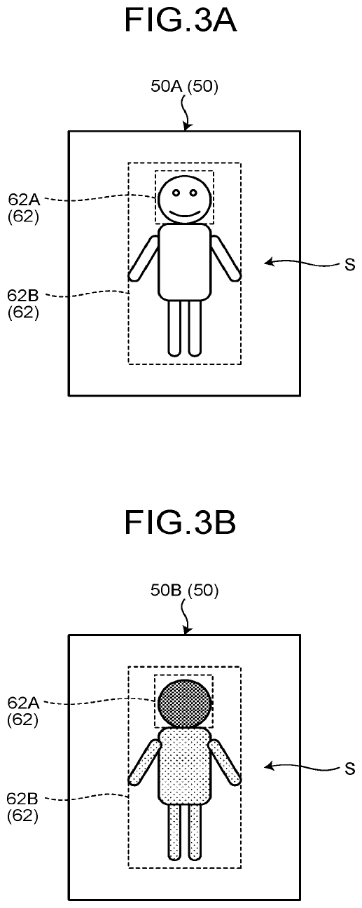

FIGS. 3A and 3B are schematic diagrams of examples of the image 50 included in the training data 40. FIG. 3A illustrates an image 50A. FIG. 3B illustrates an image 50B. The Image 50A and the image 50B are the examples of the image 50.

In the present embodiment, a mode in which the image 50 is an image including a subject S will be described as an example. The subject S may be any of an element reflected in the image 50 by photographing and an element generated or synthesized by synthesis processing or the like. That is, the image 50 may be any of an image obtained by photographing, an image in which at least a part of the image obtained by photographing is synthesized or processed, a synthetic image, a processed image, and a generated image.

In the present embodiment, a mode in which the subject S is a person will be described as an example. Furthermore, in the present embodiment, a description will be given, as an example, as to a mode in which an attribute to be identified of the first learning model 30 is face orientation of the subject S. The face orientation of the subject S is information indicating a direction in which a face of the subject S faces. The face orientation of the subject S is represented by, for example, an angle of the face with respect to a reference direction. The face orientation of the subject S is represented by, for example, a roll angle, a pitch angle, a yaw angle, and the like with a body axis direction of the subject S, which is a person, as a reference direction.

In the present embodiment, a description will be given, as an example, as to a mode in which the first learning model 30 is a learning model that uses a first identification target region 62A included in the image 50 to identify the attribute, which is the face orientation, from the first identification target region 62A.

The first identification target region 62A is an example of an identification target region 62, and is the identification target region 62 used for learning of the first learning model 30. The first identification target region 62A is determined in advance according to the type of the attribute to be identified by the first learning model 30. In the present embodiment, a description will be given, as an example, as to a mode in which the first identification target region 62A is a face image region of the subject S. The face image region is a region representing the face of the subject S, which is a person in the image 50.

That is, in the present embodiment, a description will be given, as an example, as to a mode in which the first learning model 30 to be learned is a learning model that receives a face image region, which is the first identification target region 62A included in the image 50, and outputs a face orientation as an attribute of the image 50.

It is noted that the type of the attribute may be set in advance according to an application target of the first learning model 30 or the like, and is not limited to the face orientation. In addition, the first identification target region 62A may be set in advance according to the type of the attribute to be identified of the first learning model 30, and is not limited to the face image region.

Referring back to FIG. 1, the description will be continued.

The pseudo label estimation unit 20B estimates a pseudo label, which is an estimation result of the attribute of the image 50 of the unlabeled training data 44, based on the identification target region 62 according to the type of the attribute to be identified by the first learning model 30 in the image 50 of the unlabeled training data 44.

First, an outline of estimation processing of the pseudo label will be described. Hereinafter, the estimation processing of the pseudo label may be described as pseudo label estimation processing.

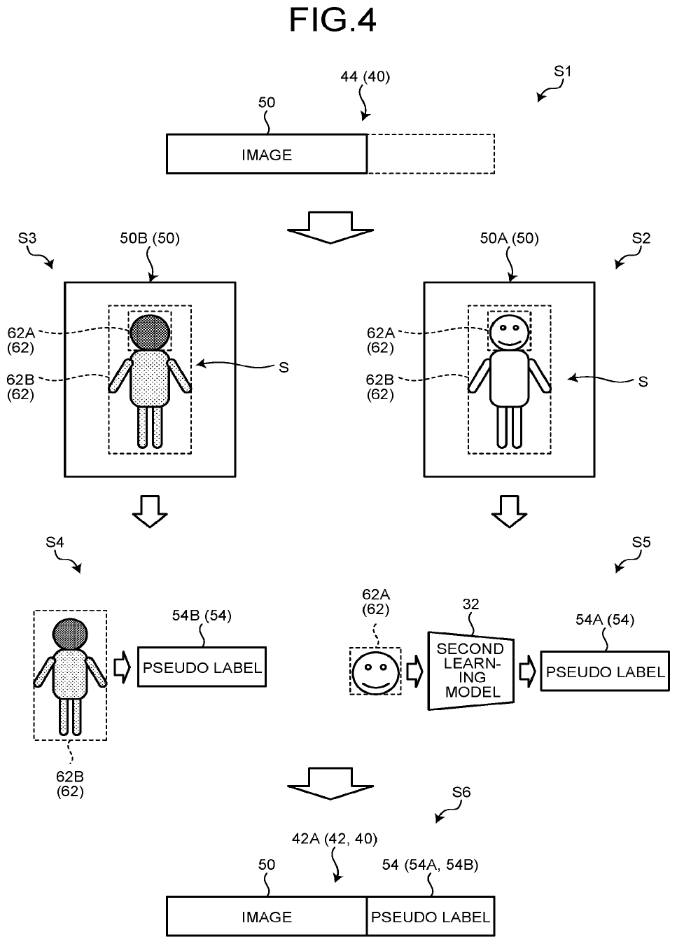

FIG. 4 is an explanatory diagram illustrating an example of a flow of the pseudo label estimation processing by the pseudo label estimation unit 20B. An image 50A and an image 50B illustrated in FIG. 4 are similar to the image 50A and the image 50B illustrated in FIGS. 3A and 3B, respectively.

The pseudo label estimation unit 20B estimates a pseudo label 54, which is the estimation result of the attribute of the image 50 of the unlabeled training data 44, and generates first labeled training data 42A.

First, the acquisition unit 20A acquires the training data 40 including the unlabeled training data 44 (Step S1). The pseudo label estimation unit 20B executes estimation processing of the pseudo label 54 by using the image 50 included in the unlabeled training data 44 acquired by the acquisition unit 20A.

The pseudo label estimation unit 20B estimates the pseudo label 54 based on an identification target region 62 according to the type of the attribute to be identified of the first learning model 30 included in the image 50 of the unlabeled training data 44. The pseudo label estimation unit 20B determines in advance which identification target region 62 in the image 50 is used for estimation of the pseudo label 54 in a case where what kind of estimatable condition is satisfied according to the type of the attribute to be identified of the first learning model 30. The estimatable condition will be described later.

Specifically, the pseudo label estimation unit 20B determines whether it is difficult to estimate the attribute using the first identification target region 62A in the image 50 of the unlabeled training data 44.

FIG. 4 illustrates the image 50B as an example of the image 50 in a case where it is difficult to estimate the attribute using the first identification target region 62A. In addition, FIG. 4 illustrates the image 50A as an example of the image 50 in a case where the attribute can be estimated using the first identification target region 62A.

For example, it is assumed that the image 50 included in the unlabeled training data 44 acquired by the acquisition unit 20A is the image 50A (Step S2). In the image 50A, the head of the subject S in a state in which the face orientation can be estimated from the first identification target region 62A is reflected in the first identification target region 62A, which is a face image region. Specifically, parts of the head such as eyes, nose, and mouth used for estimation of the face orientation are reflected in the first identification target region 62A of the image 50A. In this case, the pseudo label estimation unit 20B can estimate the pseudo label, which is the estimation result of the face orientation, from the face image region, which is the first identification target region 62A of the image 50A.

On the other hand, it is assumed that the image 50 included in the unlabeled training data 44 acquired by the acquisition unit 20A is the image 50B (Step S3). The image 50B is an example of the image 50 obtained by photographing the subject S from the side of the back of the head. In the image 50B, the head of the subject S in a state in which the face orientation can be estimated from the first identification target region 62A is not reflected in the first identification target region 62A, which is the face image region. Specifically, at least a part of parts of the head such as eyes, nose, and mouth used for estimation of the face orientation is not reflected in the first identification target region 62A of the image 50B. In this case, it is difficult for the pseudo label estimation unit 20B to estimate the pseudo label 54, which is the estimation result of the face orientation, from the face image region, which is the first identification target region 62A of the image 50A.

Therefore, when determining that it is difficult to estimate the attribute using the first identification target region 62A in the image 50 of the unlabeled training data 44 (Step S3), the pseudo label estimation unit 20B estimates a pseudo label 54B based on a second identification target region 62B, which is an identification target region 62 different from the first identification target region 62A (Step S4). The pseudo label 54B is the pseudo label 54 estimated from the second identification target region 62B, and is an example of the pseudo label 54.

On the other hand, when determining that the attribute can be estimated using the first identification target region 62A in the image 50 of the unlabeled training data 44 (Step S2), the pseudo label estimation unit 20B estimates a pseudo label 54A based on the first identification target region 62A (Step S5). The pseudo label 54A is the pseudo label 54 estimated from the first identification target region 62A, and is an example of the pseudo label 54.

Then, the pseudo label estimation unit 20B generates the first labeled training data 42A including a pair of the image 50 of the unlabeled training data 44 and the estimated pseudo label 54 (Step S6).

Next, the estimation processing of the pseudo label 54 by the pseudo label estimation unit 20B will be described in detail.

First, a description will be given as to details of determination processing about whether it is difficult to estimate the attribute using the first identification target region 62A.

The pseudo label estimation unit 20B determines whether it is difficult to estimate the attribute using the first identification target region 62A by using a method according to the type of the attribute to be identified by the first learning model 30 and the first identification target region 62A in the image 50 of the unlabeled training data 44.

For example, the pseudo label estimation unit 20B determines whether a state of the subject S represented by the identification target region 62 in the image 50 of the unlabeled training data 44 satisfies a predetermined estimatable condition.

The estimatable condition is a condition for estimating an attribute from the first identification target region 62A. In other words, the estimatable condition is a condition used for determining whether the attribute can be estimated from the first identification target region 62A.

The state and the estimatable condition of the subject S represented by the identification target region 62 may be determined in advance according to the type of the attribute to be identified by the first learning model 30.

As described above, in the present embodiment, a description will be given on the assumption that the first identification target region 62A is the face image region of the subject S, and the type of the attribute to be identified by the first learning model 30 is the face orientation.

In this case, the pseudo label estimation unit 20B uses, for example, a body angle of the subject S as the state of the subject S represented by the identification target region 62. The body angle is information representing the orientation of the body of the subject S by an angle. The body angle is represented by, for example, a roll angle, a pitch angle, a yaw angle, and the like with a body axis direction of the subject S, which a person, as a reference direction.

The pseudo label estimation unit 20B uses a predetermined threshold value of the body angle of the subject S as the estimatable condition. This threshold value may be determined in advance. For example, as the threshold value, a threshold value for distinguishing between the body angle of the subject S in a state in which the face orientation can be estimated from the face image region and the body angle of the subject S in a state in which it is difficult to estimate the face orientation from the face image region may be determined in advance.

The body angle of the subject S is specified, for example, by detecting the head and a skeleton of a body part other than the head in the subject S. That is, the body angle of the subject S is specified by detecting the skeleton included in the identification target region 62 different from the first identification target region 62A, which is the face image region of the subject S. Therefore, in the present embodiment, the second identification target region 62B is used as the identification target region 62 used to determine whether the estimatable condition is satisfied.

The second identification target region 62B is an example of the identification target region 62, and is the identification target region 62 different from the first identification target region 62A in the image 50. The first identification target region 62A and the second identification target region 62B may be the identification target regions 62 having different positions, sizes, and at least a part of ranges in one image 50. In addition, the first identification target region 62A and the second identification target region 62B may be regions in which at least some regions overlap each other in one image 50.

In the present embodiment, a description will be given, as an example, as to a mode in which the first identification target region 62A is a face image region and the second identification target region 62B is a whole body region of the subject S included in the image 50. The whole body region is a region including the head and parts other than the head of the subject S. Therefore, the whole body region may be a region including the head and at least a part of the region other than the head in the whole body of the subject S, and is not limited to a region including the entire region from the top of the head to the tip of the foot of the subject S, which is a person.

The pseudo label estimation unit 20B specifies the second identification target region 62B, which is the whole body region of the subject S, from the image 50 of the unlabeled training data 44. A known image processing technique may be used as a method of specifying the second identification target region 62B, which is the whole body region, from the image 50. Then, the pseudo label estimation unit 20B detects the skeleton of the subject S from the second identification target region 62B, which is the specified whole body region of the subject S.

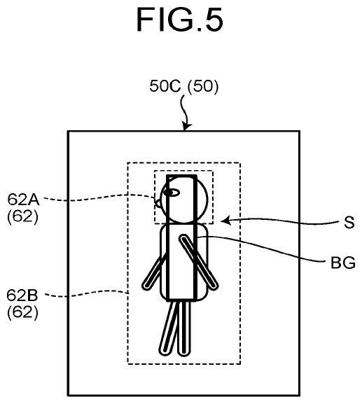

FIG. 5 is an explanatory diagram of an example of skeleton detection processing by the pseudo label estimation unit 20B. FIG. 5 illustrates an image 50C as an example. The image 50C is an example of the image 50.

For example, the pseudo label estimation unit 20B detects a skeleton BG of the subject S from the second identification target region 62B, which is the whole body region of the subject S included in the image 50. As a method of detecting the skeleton BG of the subject S from the image, a known human pose estimation method may be used.

Then, the pseudo label estimation unit 20B estimates the body angle of the subject S using information such as the position of each of one or a plurality of parts forming the body represented by the detected skeleton BG and the angle of each of one or a plurality of joints. As a method of estimating the body angle of the subject S from the detection result of the skeleton BG, a known method may be used. The body angle is represented by, for example, a roll angle, a pitch angle, a yaw angle, and the like with the body axis direction of the subject S, which is a person, as a reference direction.

Referring back to FIG. 4, the description will be continued. When the body angle of the subject S is equal to or larger than a threshold value, the pseudo label estimation unit 20B determines that the state of the subject S represented by the second identification target region 62B of the image 50 does not satisfy the estimatable condition, and it is difficult to estimate the attribute using the first identification target region 62A in the image 50 (Step S3).

When determining that it is difficult to estimate the attribute using the first identification target region 62A in the image 50 of the unlabeled training data 44 (Step S3), the pseudo label estimation unit 20B estimates the pseudo label 54B based on the second identification target region 62B (Step S4).

Specifically, the pseudo label estimation unit 20B estimates a predetermined pseudo label according to the state of the subject S represented by the second identification target region 62B in the image 50 of the unlabeled training data 44 (Step S4). As described above, in the present embodiment, the body angle of the subject S is used as the state of the subject S. Therefore, the pseudo label estimation unit 20B estimates the pseudo label 54B using the body angle of the subject S specified based on the second identification target region 62B, which is the whole body region of the subject S, in the image 50 of the unlabeled training data 44.

For example, it is assumed that an angle (for example, an angle in the yaw direction) represented by the estimated body angle of the subject S is an angular range representing a person facing straight backwards. In this case, the pseudo label estimation unit 20B estimates “straight backward orientation” as the pseudo label 54B representing the face orientation, which is the attribute of the image 50.

The pseudo label estimation unit 20B may store in advance a database or the like in which the body angle and the pseudo label 54B are associated with each other, and may read the pseudo label 54B corresponding to the estimated body angle in the database, thereby estimating the pseudo label 54B. In addition, the pseudo label estimation unit 20B may store in advance a discriminator such as a learning model that receives the body angle and outputs the pseudo label 54B, and may estimate the pseudo label using the discriminator. For this discriminator, it is preferable to use a learning model or the like that outputs an identification result with high accuracy although a processing speed is slower than that of the first learning model 30.

As described above, when determining that it is difficult to estimate the attribute using the first identification target region 62A in the image 50 of the unlabeled training data 44, the pseudo label estimation unit 20B estimates the pseudo label 54B based on the second identification target region 62B (Step S3 and Step S4).

Then, the pseudo label estimation unit 20B generates the first labeled training data 42A including a pair of the image 50 of the unlabeled training data 44 and the estimated pseudo label 54B (Step S6).

On the other hand, when the body angle of the subject S is less than the threshold value, the pseudo label estimation unit 20B determines that the state of the subject S represented by the second identification target region 62B of the image 50 satisfies the estimatable condition, and the attribute can be estimated using the first identification target region 62A in the image 50 (refer to Step S2 and Step S5).

When determining that the attribute can be estimated using the first identification target region 62A in the image 50 of the unlabeled training data 44 (Step S2), the pseudo label estimation unit 20B estimates the pseudo label 54A based on the first identification target region 62A (Step S5).

Specifically, the pseudo label estimation unit 20B specifies a face image region, which is the first identification target region 62A, from the image 50 of the unlabeled training data 44. A known image processing technique may be used to specify the face image region. Then, the pseudo label estimation unit 20B estimates the pseudo label 54A from the first identification target region 62A of the image 50 of the unlabeled training data 44 using a second learning model 32 learned in advance.

The second learning model 32 is a learning model having a processing speed slower than that of the first learning model 30.

That is, the first learning model 30 is a learning model having a processing speed higher than that of the second learning model 32. The high processing speed means that the time from the input of the image 50 to the learning model to the output of the identification result is shorter.

In addition, the first learning model 30 is a learning model smaller in size than the second learning model 32. The size of the learning model may be referred to as a parameter size. The parameter size is represented by the size of a convolutional filter coefficient of a convolutional layer of the learning model and the weight size of a fully connected layer. As the parameter size is larger, at least one of the number of convolutional filters, the number of channels of intermediate data output from the convolutional layer, and the number of parameters is larger. Therefore, the processing speed is faster for a learning model having a smaller size, and the processing speed is slower for a learning model having a larger size. In addition, the larger the size of the learning model, the slower the processing speed, but the higher the identification accuracy.

That is, the second learning model 32 is larger in size and slower in processing speed than the first learning model 30, and has a larger number of parameters, a larger number of convolutional filters, and the like. Therefore, the second learning model 32 is a model that can output a more accurate identification result than the first learning model 30 although the processing speed thereof is slow.

The pseudo label estimation unit 20B inputs a face image region, which is the first identification target region 62A specified from the image 50 included in the unlabeled training data 44, to the second learning model 32. Then, the pseudo label estimation unit 20B acquires an attribute representing a face orientation as an output from the second learning model 32. The pseudo label estimation unit 20B acquires the attribute output from the second learning model 32 to estimate the attribute as the pseudo label 54A.

Then, the pseudo label estimation unit 20B generates the first labeled training data 42A including a pair of the image 50 of the unlabeled training data 44 and the estimated pseudo label 54A (Step S6).

Referring back to FIG. 1, the description will be continued. Next, the learning unit 20C will be described.

The learning unit 20C learns the first learning model 30 that identifies the attribute of the image 50 from the image 50 by using the first labeled training data 42A. The first labeled training data 42A is the training data 40 obtained by assigning the pseudo label 54 estimated by the pseudo label estimation unit 20B to the image 50 of the unlabeled training data 44.

As described above, the acquisition unit 20A may further acquire the second labeled training data 42B. Therefore, in the present embodiment, the learning unit 20C may learn the first learning model 30 by using the first labeled training data 42A and the second labeled training data 42B.

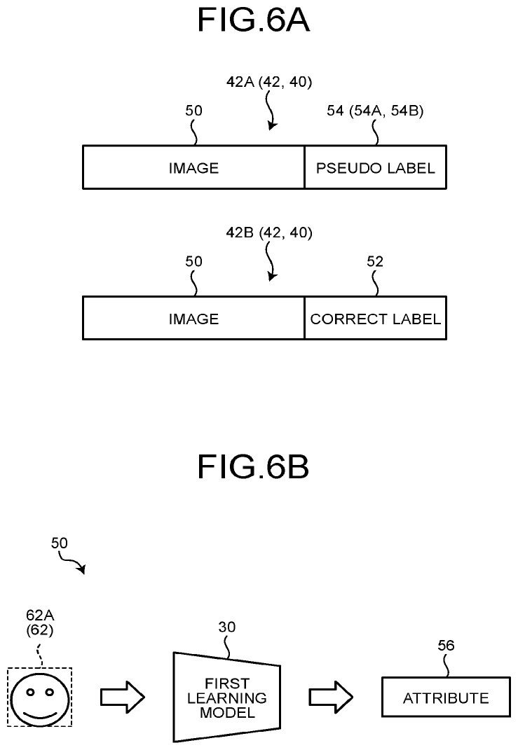

FIGS. 6A and 6B are explanatory diagrams of examples of learning by the learning unit 20C.

As illustrated in FIG. 6A, the learning unit 20C uses the first labeled training data 42A to which the pseudo label 54 is assigned and the second labeled training data 42B to which the correct label 52 is assigned for learning of the first learning model 30.

As illustrated in FIG. 6B, the learning unit 20C learns the first learning model 30 that outputs an attribute 56, which is the face orientation, from the first identification target region 62A, which is the face image region of the image 50, based on the image 50 included in the training data 40, which is the first labeled training data 42A or the second labeled training data 42B, and the pseudo label 54 or the correct label 52 assigned to the training data 40.

The learning unit 20C specifies the first identification target region 62A, which is the face image region, from the image 50 included in the training data 40, and inputs the specified first identification target region 62A to the first learning model 30. Then, the learning unit 20C acquires the attribute 56, which is the face orientation output from the first learning model 30, by the input of the first identification target region 62A, as the attribute 56 estimated by the first learning model 30.

Furthermore, the learning unit 20C learns the first learning model 30 by updating parameters of the first learning model 30 or the like so as to minimize a least square error L between the attribute 56, which is the face orientation estimated by the first learning model 30 from the image 50 included in the training data 40, and the correct label 52 or the pseudo label 54, which is the face orientation included in the training data 40.

The least square error L is represented by the following formula (1).

$$L = {\sum }_{i = 1}^{N} ( {( {α}_{i} - {x}_{i} )}^{2} + {( {β}_{i} - y )}^{2} + {( {γ}_{i} - {z}_{i} )}^{2} ) \qquad ( 1 )$$

In formula (1), L represents a least square error. i (i=1, . . . , N) is identification information of the training data 40. N is an integer of 2 or more. (xᵢ, yᵢ, zᵢ) is an angle representing the face orientation represented by the pseudo label 54. xᵢ represents a roll angle, yᵢ represents a pitch angle, and zᵢ represents a yaw angle. (αᵢ, βᵢ, γᵢ) is an angle representing the face orientation output from the first learning model 30. αᵢ represents a roll angle, βᵢ represents a pitch angle, and γᵢ represents a yaw angle.

In addition, when using the correct label 52 of the second labeled training data 42B, the learning unit 20C may use an angle representing the face orientation represented by a correct label 52B of the second labeled training data 42B as (xᵢ, yᵢ, zᵢ) in formula (1).

In addition, the learning unit 20C may perform learning so as to minimize the least square error L using both the pseudo label 54B estimated from the second identification target region 62B and the pseudo label 54A estimated from the first identification target region 62A using the second learning model 32 as the second labeled training data 42B.

In this case, the least square error L is represented by the following formula (2).

$$L = {\sum }_{i = 1}^{N} ( {( {α}_{i} - {x}_{i} )}^{2} + {( {β}_{i} - {y}_{i} )}^{2} + {( {γ}_{i} - {z}_{i} )}^{2} ) + λ ( {( {α}_{i} - {α}_{i}^{′} )}^{2} + {( {β}_{i} - {β}_{i}^{′} )}^{2} + {( {γ}_{i} - {γ}_{i}^{′} )}^{2} ) \qquad ( 2 )$$

In formula (2), L represents a least square error. i (i=1, . . . , N) is identification information of the training data 40. N is an integer of 2 or more. (αᵢ, βᵢ, γᵢ) is an angle representing the face orientation output from the first learning model 30. αᵢ represents a roll angle, βᵢ represents a pitch angle, and γᵢ represents a yaw angle. (xᵢ, yᵢ, zᵢ) is an angle representing the face orientation represented by the pseudo label 54B estimated from the second identification target region 62B. xᵢ represents a roll angle, yᵢ represents a pitch angle, and zᵢ represents a yaw angle.

In formula (2), (α′ᵢ, β′ᵢ, γ′ᵢ) is an angle representing the face orientation represented by the pseudo label 54A estimated from the first identification target region 62A using the second learning model 32. α′ᵢ represents a roll angle, β′ᵢ represents a pitch angle, and γ′ᵢ represents a yaw angle. In formula (2), λ is a parameter having a value larger than 0.

A method of learning the first learning model 30 so as to minimize the least square error L represented by formula (2) is a method called knowledge distillation. By using knowledge distillation, the learning unit 20C can learn the first learning model 30 so as to mimic the output of the second learning model 32 serving as a supervision, and can learn the first learning model 30 capable of identifying an attribute with higher accuracy.

It is noted that the learning unit 20C may set in advance which of the labeled training data 42, the first labeled training data 42A to which the pseudo label 54A is assigned, and the first labeled training data 42A to which the pseudo label 54B is assigned is preferentially used for learning. Then, the learning unit 20C may learn the first learning model 30 by preferentially using the training data 40 having a high priority according to setting contents.

Furthermore, the learning unit 20C may set the batch size at the time of learning in advance. For example, the learning unit 20C may set in advance the number of pieces to be used at the time of learning for each of the labeled training data 42, the first labeled training data 42A to which the pseudo label 54A is assigned, and the first labeled training data 42A to which the pseudo label 54B is assigned. Then, the learning unit 20C may learn the first learning model 30 by using the number of pieces of training data 40 according to the set number.

Referring back to FIG. 1, the description will be continued. Next, the output control unit 20D will be described.

The output control unit 20D outputs the first learning model 30 learned by the learning unit 20C. The output of the first learning model 30 means at least one of display of information representing the first learning model 30 on the UI unit 14, storage of the first learning model 30 in the storage unit 12, and transmission of the first learning model 30 to the external information processing device. For example, the output control unit 20D transmits the first learning model 30 learned by the learning unit 20C to the external information processing device of the application target of the first learning model 30 via the communication unit 16, thereby outputting the first learning model 30.

Next, a description will be given as to an example of a flow of information processing executed by the image processing unit 10 of the present embodiment.

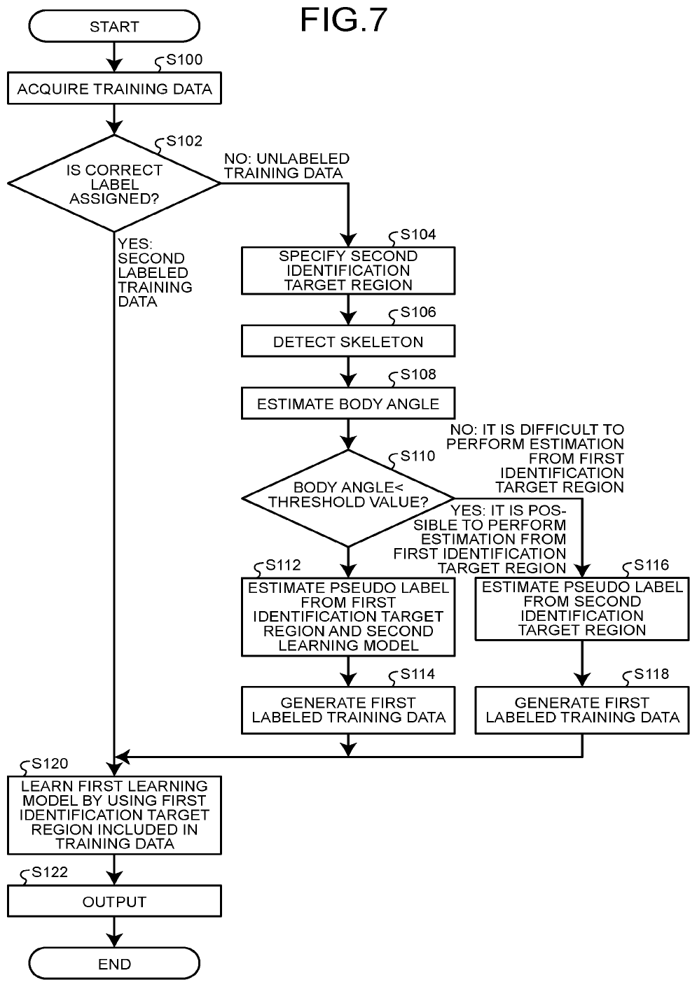

FIG. 7 is a flowchart illustrating the example of the flow of the information processing executed by the image processing unit 10 of the present embodiment.

The acquisition unit 20A acquires the training data 40 including the second labeled training data 42B and the unlabeled training data 44 (Step S100).

The pseudo label estimation unit 20B determines whether the training data 40 to be processed among the training data 40 acquired by the acquisition unit 20A is the second labeled training data 42B to which the correct label 52 is assigned (Step S102).

When the training data 40 to be processed is the second labeled training data 42B to which the correct label 52 is assigned (Step S102: Yes), the pseudo label estimation unit 20B outputs the second labeled training data 42B to the learning unit 20C and the processing proceeds to Step S120 to be described later.

On the other hand, when the training data 40 to be processed is the unlabeled training data 44 to which the correct label 52 is not assigned (Step S102: No), the processing proceeds to Step S104.

In Step S104, the pseudo label estimation unit 20B specifies the second identification target region 62B of the image 50 included in the unlabeled training data 44 (Step S104). That is, the pseudo label estimation unit 20B specifies the second identification target region 62B, which is the whole body region of the subject S included in the image 50.

The pseudo label estimation unit 20B detects the skeleton BG of the subject S from the second identification target region 62B, which is the whole body region of the subject S specified in Step S104 (Step S106). Then, the pseudo label estimation unit 20B estimates the body angle of the subject S from the detection result of the skeleton BG detected in Step S106 (Step S108).

Next, the pseudo label estimation unit 20B determines whether the body angle estimated in Step S108 is less than the threshold value, which is the estimatable condition (Step S110). That is, the pseudo label estimation unit 20B determines whether the state of the subject S represented by the identification target region 62 of the image 50 included in the unlabeled training data 44 satisfies the estimatable condition for estimating the attribute from the first identification target region 62A by the processing in Steps S104 to S110.

When the body angle is less than the threshold value (Step S110: Yes), the pseudo label estimation unit 20B determines that the face orientation can be estimated using the first identification target region 62A, which is the face image region of the image 50. Then, the processing proceeds to Step S112.

In Step S112, the pseudo label estimation unit 20B estimates the pseudo label 54A from the first identification target region 62A and the second learning model 32 (Step S112). The pseudo label estimation unit 20B inputs a face image region, which is the first identification target region 62A included in the image 50 of the unlabeled training data 44, to the second learning model 32. Then, the pseudo label estimation unit 20B acquires the attribute representing the face orientation as an output from the second learning model 32. The pseudo label estimation unit 20B acquires the attribute output from the second learning model 32 to estimate the attribute as the pseudo label 54A.

Then, the pseudo label estimation unit 20B generates the first labeled training data 42A including a pair of the image 50 of the unlabeled training data 44 and the pseudo label 54A estimated in Step S112 (Step S114). Then, the processing proceeds to Step S120 to be described later.

On the other hand, when determining that the body angle is equal to or larger than the threshold value in Step S110 (Step S110: No), the pseudo label estimation unit 20B determines that it is difficult to estimate the face orientation using the first identification target region 62A, which is the face image region of the image 50. That is, when the body angle of the subject S is equal to or larger than the threshold value, the pseudo label estimation unit 20B determines that the state of the subject S represented by the second identification target region 62B of the image 50 does not satisfy the estimatable condition, and it is difficult to estimate the attribute using the first identification target region 62A in the image 50. Then, the processing proceeds to Step S116.

In Step S116, the pseudo label estimation unit 20B estimates the pseudo label 54B from the second identification target region 62B, which is the whole body region in the image 50 of the unlabeled training data 44 (Step S116). As described above, for example, the pseudo label estimation unit 20B estimates the pseudo label 54B such as “straight backward orientation” using the body angle of the subject S specified based on the second identification target region 62B, which is the whole body region of the subject S in the image 50 of the unlabeled training data 44.

Then, the pseudo label estimation unit 20B generates the first labeled training data 42A including a pair of the image 50 of the unlabeled training data 44 and the pseudo label 54B estimated in Step S116 (Step S118). Then, the processing proceeds to Step S120.

In Step S120, the learning unit 20C learns the first learning model 30 by using the first identification target region 62A included in the training data 40 (Step S120).

The learning unit 20C receives, as the training data 40, the second labeled training data 42B determined in Step S102 (Step S102: Yes), the first labeled training data 42A generated in Step S114, and the first labeled training data 42A generated in Step S118. Then, the learning unit 20C specifies the first identification target region 62A, which the face image region from the image 50 included in the training data 40, and inputs the first identification target region 62A to the first learning model 30. Then, the learning unit 20C acquires the attribute 56, which is the face orientation output from the first learning model 30, by the input of the first identification target region 62A, as the attribute 56 estimated by the first learning model 30.

Furthermore, the learning unit 20C learns the first learning model 30 by, for example, updating the parameters of the first learning model 30 so as to minimize the least square error L between the attribute 56, which is the face orientation estimated by the first learning model 30 from the image 50 included in the training data 40, and the correct label 52 or the pseudo label 54 (pseudo label 54A and pseudo label 54B), which is the face orientation included in the training data 40.

The output control unit 20D outputs the first learning model 30 learned in Step S120 (Step S122). Then, this routine is ended.

As described above, the image processing apparatus 1 according to the present embodiment includes the acquisition unit 20A, the pseudo label estimation unit 20B, and the learning unit 20C. The acquisition unit 20A acquires the unlabeled training data 44 including the image 50 to which the correct label 52 of the attribute is not assigned. The pseudo label estimation unit 20B estimates the pseudo label 54, which is the estimation result of the attribute of the image 50 of the unlabeled training data 44, based on the identification target region 62 according to the type of the attribute to be identified by the first learning model 30 to be learned in the image 50 of the unlabeled training data 44. The learning unit 20C learns the first learning model 30 that identifies the attribute 56 of the image 50 by using the first labeled training data 42A obtained by assigning the pseudo label 54 to the image 50 of the unlabeled training data 44.

Here, the related art discloses a technique of performing learning while estimating the attribute of the image 50 included in the unlabeled training data 44. In the related art, the learning model to be learned is learned while estimating the attribute from the same identification target region 62 as the learning model to be learned. However, depending on the image included in the unlabeled training data 44, it may be difficult to estimate the attribute from the same identification target region 62 as the learning model to be learned. For this reason, in the related art, the attribute of the image 50 of the unlabeled training data 44 cannot be estimated, and as a result, the identification accuracy of the learning model to be learned may deteriorate.

On the other hand, in the image processing apparatus 1 according to the present embodiment, the pseudo label estimation unit 20B estimates the pseudo label 54, which is the estimation result of the attribute of the image 50 of the unlabeled training data 44, based on the identification target region 62 according to the type of the attribute to be identified by the first learning model 30 to be learned in the image 50 of the unlabeled training data 44. Then, the learning unit 20C learns the first learning model 30 that identifies the attribute 56 of the image 50 by using the first labeled training data 42A obtained by assigning the pseudo label 54 to the image 50 of the unlabeled training data 44.

As described above, in the present embodiment, the image processing apparatus 1 estimates the pseudo label 54 not based on the fixed identification target region 62 but based on the identification target region 62 according to the type of the attribute to be identified by the first learning model 30 to be learned. Then, the image processing apparatus 1 learns the first learning model 30 by using the image 50 to which the pseudo label 54 is assigned as the first labeled training data 42A.

Therefore, the image processing apparatus 1 according to the present embodiment can assign the pseudo label 54 to the unlabeled training data 44 with high accuracy. Then, the image processing apparatus 1 according to the present embodiment learns the first learning model 30 by using the first labeled training data 42A to which the pseudo label 54 is assigned. Therefore, the image processing apparatus 1 according to the present embodiment can learn the first learning model 30 capable of identifying the attribute of the image 50 with high accuracy.

Therefore, the image processing apparatus 1 according to the present embodiment can provide the first learning model 30 (learning model) capable of identifying the attribute of the image 50 with high accuracy.

In addition, in the related art, since learning is performed while estimating the attribute of the image 50 included in the unlabeled training data 44, it is necessary to separately prepare an image that does not include a face image region, which is an attribute to be identified of the first learning model 30, and to use the image as training data. On the other hand, in the image processing apparatus 1 according to the present embodiment, the pseudo label estimation unit 20B estimates the pseudo label 54 from the image 50 included in the unlabeled training data 44 based on the identification target region 62 according to the type of the attribute to be identified by the first learning model 30. Therefore, in the image processing apparatus 1 according to the present embodiment, it is possible to learn the first learning model 30 without separately preparing the image that does not include the face image region, which is the attribute to be identified of the first learning model 30. Therefore, the image processing apparatus 1 according to the present embodiment can easily learn the first learning model 30 with a simple configuration in addition to the above-described effects.

When determining that the attribute can be estimated using the first identification target region 62A in the image 50 of the unlabeled training data 44, the pseudo label estimation unit 20B of the image processing apparatus 1 according to the present embodiment estimates the pseudo label 54A using the first identification target region 62A and the second learning model 32. As described above, the second learning model 32 is a learning model having a processing speed slower than that of the first learning model 30, but is a model capable of outputting an identification result with higher accuracy than that of the first learning model 30. On the other hand, the first learning model 30 to be learned is a learning model having a processing speed faster than that of the first learning model 30, but the accuracy of the identification result may be inferior to that of the second learning model 32.

However, the learning unit 20C of the image processing apparatus 1 according to the present embodiment learns the first learning model 30 by using the first labeled training data 42A to which the pseudo label 54A is assigned, the pseudo label 54A being estimated by using the second learning model 32 capable of outputting a highly accurate identification result. Therefore, the learning unit 20C of the image processing apparatus 1 according to the present embodiment can learn the first learning model 30 that has a high processing speed and can identify the attribute of the image 50 with high accuracy.

### Second Embodiment

In the present embodiment, a description will be given, as an example, as to a mode in which the first learning model 30 to be learned is a learning model having a type of an attribute to be identified different from that in the above-described embodiment.

It is noted that the same reference numerals will be given to portions indicating the same functions or configurations as those in the above embodiment, and a detailed description thereof may be omitted.

FIG. 1 is a schematic diagram of an example of an image processing apparatus 1B according to the present embodiment.

The image processing apparatus 1B is similar to the image processing apparatus 1 according to the above embodiment except that an image processing unit 10B is provided instead of the image processing unit 10. The image processing unit 10B is similar to the image processing unit 10 of the above embodiment except that a control unit 22 is provided instead of the control unit 20. The control unit 22 is similar to the control unit 20 of the above embodiment except that a pseudo label estimation unit 22B is provided instead of the pseudo label estimation unit 20B.

In the present embodiment, a description will be given, as an example, as to a mode in which an attribute to be identified of the first learning model 30 is gender of the subject S. In the present embodiment, in the same manner as in the above embodiment, a description will be given, as an example, as to a mode in which the first identification target region 62A is a face image region of the subject S. That is, in the present embodiment, a description will be given, as an example, as to a mode in which the first learning model 30 to be learned is a learning model that receives the face image region, which is the first identification target region 62A of the image 50, and outputs the gender of the subject S as an attribute of the image 50.

In addition, in the present embodiment, a description will be given, as an example, as to a mode in which the second identification target region 62B, which is the identification target region 62 different from the first identification target region 62A, is a whole body region of the subject S in the same manner as in the above embodiment.

In the same manner as that of the pseudo label estimation unit 20B of the above embodiment, the pseudo label estimation unit 22B estimates the pseudo label 54, which is an estimation result of the attribute of the image 50 of the unlabeled training data 44, based on the identification target region 62 according to the type of the attribute to be identified by the first learning model 30 in the image 50 of the unlabeled training data 44.

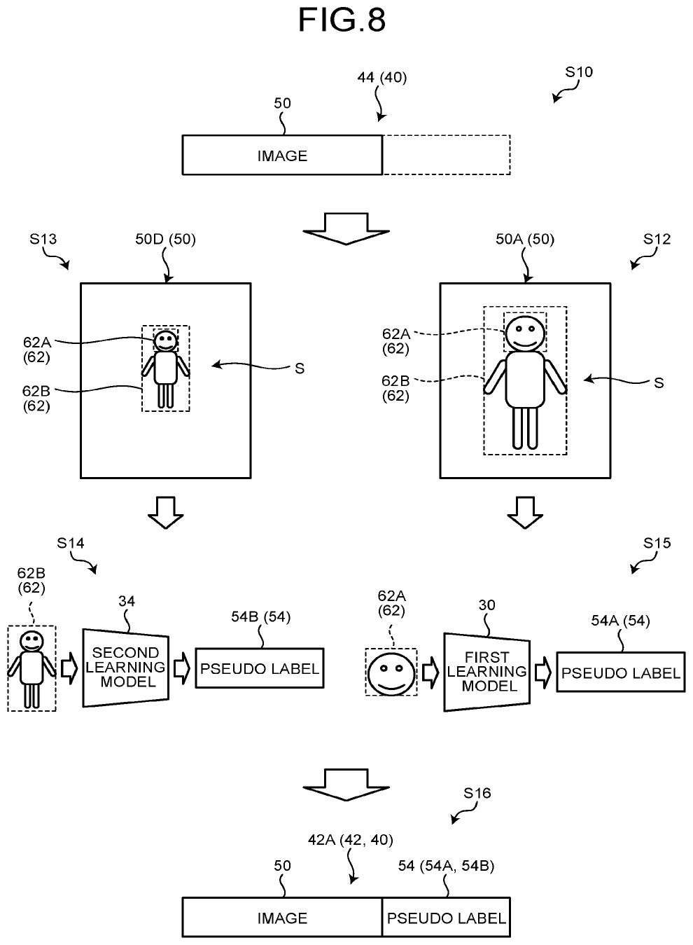

FIG. 8 is an explanatory diagram illustrating an example of a flow of pseudo label estimation processing according to the present embodiment. An image 50A illustrated in FIG. 8 is similar to the image 50A illustrated in FIG. 3A. An image 50D is an example of the image 50.

The pseudo label estimation unit 22B executes estimation processing of the pseudo label 54 by using the image 50 included in the unlabeled training data 44 acquired by the acquisition unit 20A (Step S10).

In the same manner as that of the pseudo label estimation unit 20B, the pseudo label estimation unit 22B determines whether it is difficult to estimate the attribute using the first identification target region 62A in the image 50 of the unlabeled training data 44. In the present embodiment, the pseudo label estimation unit 22B determines whether it is difficult to estimate the gender of the subject S, which is the attribute, using the first identification target region 62A, which is the face image region in the image 50.

FIG. 8 illustrates the image 50D as an example of the image 50 in a case where it is difficult to estimate the attribute using the first identification target region 62A. In addition, FIG. 8 illustrates the image 50A as an example of the image 50 in a case where the attribute can be estimated using the first identification target region 62A.

For example, it is assumed that the image 50 included in the unlabeled training data 44 acquired by the acquisition unit 20A is the image 50A (Step S12). In the image 50A, the head of the subject S in a state in which the gender can be estimated from the first identification target region 62A is reflected in the first identification target region 62A, which is the face image region. Specifically, in the first identification target region 62A of the image 50A, parts of the head such as eyes, nose, and mouth used for estimation of the gender are identifiably reflected. In this case, the pseudo label estimation unit 22B can estimate the pseudo label 54, which is an estimation result of the gender, from the face image region, which is the first identification target region 62A of the image 50A.

On the other hand, it is assumed that the image 50 included in the unlabeled training data 44 acquired by the acquisition unit 20A is the image 50D (Step S13). In the image 50D, the size of the region occupied by the subject S is smaller than that in the image 50A, and a size of the face image region of the subject S is smaller than that in the image 50A. Specifically, in the first identification target region 62A of the image 50D, the size of the face image region is small, and parts of the head such as eyes, nose, and mouth used for estimation of the gender are reflected in an unidentifiable state. In this case, it is difficult for the pseudo label estimation unit 22B to estimate the pseudo label 54, which is the estimation result of the gender, from the face image region, which is the first identification target region 62A of the image 50D.

Therefore, the pseudo label estimation unit 22B determines whether a state of the subject S represented by the identification target region 62 in the image 50 of the unlabeled training data 44 satisfies a predetermined estimatable condition. As described in the above embodiment, the state and the estimatable condition of the subject S represented by the identification target region 62 may be determined in advance according to the type of the attribute to be identified by the first learning model 30.

As described above, in the present embodiment, a description will be given on the assumption that the first identification target region 62A is the face image region of the subject S, and the type of the attribute to be identified by the first learning model 30 is the gender of the subject S.

In this case, the pseudo label estimation unit 22B uses, for example, a face size of the subject S as the state of the subject S represented by the identification target region 62. The face size is the size of the face image region of the subject S in the image 50. The size of the face image region is represented by, for example, the number of pixels and the area occupied by the face image region in the image 50, the ratio of the number of pixels to the entire image 50, the ratio of the area to the entire image 50, and the like.

The pseudo label estimation unit 22B uses a predetermined threshold value of the face size of the subject S as the estimatable condition. This threshold value may be determined in advance. For example, as the threshold value, a threshold value for distinguishing between a face size in a state in which the gender can be estimated from the face image region and a face size in a state in which it is difficult to estimate the gender from the face image region may be determined in advance.

Then, in a case where the face size of the subject S included in the image 50 is less than the threshold value, the pseudo label estimation unit 22B determines that the state of the subject S represented by the identification target region 62 of the image 50 does not satisfy the estimatable condition, and it is difficult to estimate the attribute using the first identification target region 62A in the image 50. On the other hand, when the face size of the subject S included in the image 50 is equal to or larger than the threshold value, the pseudo label estimation unit 22B determines that the state of the subject S represented by the identification target region 62 of the image 50 satisfies the estimatable condition, and the attribute can be estimated using the first identification target region 62A in the image 50.

Then, when determining that it is difficult to estimate the attribute using the first identification target region 62A in the image 50 of the unlabeled training data 44 (Step S13), the pseudo label estimation unit 22B estimates the pseudo label 54B based on the second identification target region 62B, which is the whole body region (Step S14).

For example, the pseudo label estimation unit 22B estimates the pseudo label 54B from the second identification target region 62B of the image 50D of the unlabeled training data 44 using a second learning model 34 learned in advance.

In the same manner as that of the second learning model 32 of the above embodiment, the second learning model 34 is a learning model having a processing speed slower than that of the first learning model 30. In addition, the second learning model 34 is a learning model larger in size than the first learning model 30, in the same manner as that of the second learning model 32 of the above embodiment. Therefore, the second learning model 34 is a model that has a processing speed slower than that of the first learning model 30 and that can output an identification result with higher accuracy than that of the first learning model 30.

The pseudo label estimation unit 22B specifies the whole body region, which is the second identification target region 62B, from the image 50D included in the unlabeled training data 44. Then, the pseudo label estimation unit 22B inputs the whole body region, which is the specified second identification target region 62B, to the second learning model 34, and acquires an attribute, which is gender, as an output from the second learning model 34. Then, the pseudo label estimation unit 22B acquires the attribute output from the second learning model 34 to estimate the attribute as the pseudo label 54B.

Then, the pseudo label estimation unit 22B generates the first labeled training data 42A including a pair of the image 50 of the unlabeled training data 44 and the estimated pseudo label 54B (Step S16).

On the other hand, when determining that the attribute can be estimated using the first identification target region 62A in the image 50 of the unlabeled training data 44 (Step S12), the pseudo label estimation unit 22B estimates the pseudo label 54A based on the first identification target region 62A (Step S15).

For example, the pseudo label estimation unit 22B estimates the pseudo label 54A from the first identification target region 62A of the image 50A of the unlabeled training data 44 using the first learning model 30 to be learned.

The pseudo label estimation unit 22B specifies a face image region, which is the first identification target region 62A, from the image 50A included in the unlabeled training data 44. Then, the pseudo label estimation unit 22B inputs the specified face image region, which is the first identification target region 62A, to the first learning model 30, and acquires an attribute, which is gender, as an output from the first learning model 30. Then, the pseudo label estimation unit 22B acquires the attribute output from the first learning model 30 to estimate the attribute as the pseudo label 54A.

Then, the pseudo label estimation unit 22B generates the first labeled training data 42A including a pair of the image 50 of the unlabeled training data 44 and the estimated pseudo label 54A (Step S16).

The learning unit 20C is similar to the learning unit 20C of the above embodiment except that the first labeled training data 42A generated by the pseudo label estimation unit 22B instead of the pseudo label estimation unit 20B is used.

Next, a description will be given as to an example of a flow of information processing executed by the image processing unit 10B of the present embodiment.

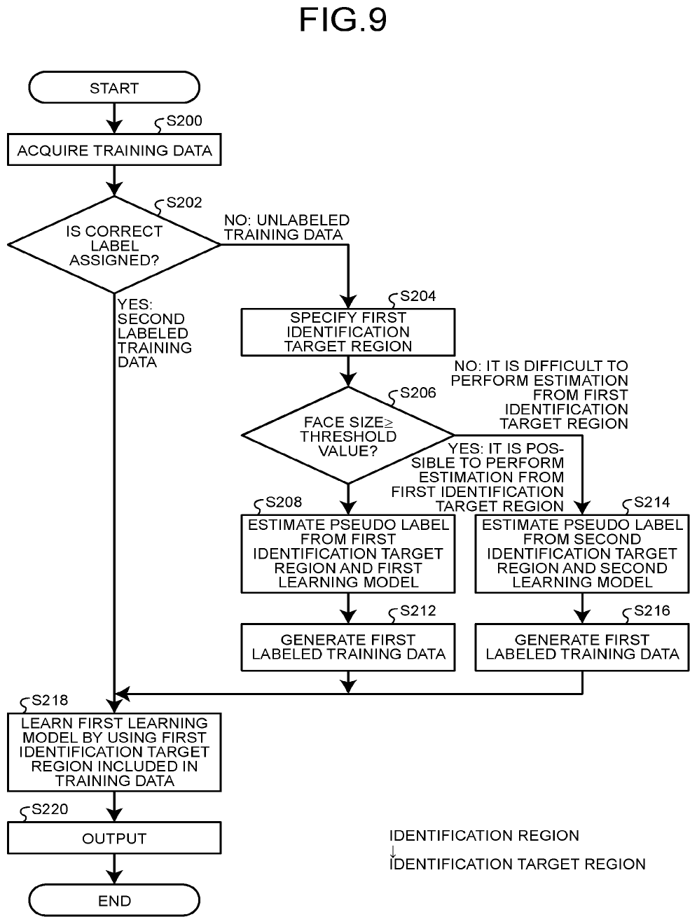

FIG. 9 is a flowchart illustrating the example of the flow of the information processing executed by the image processing unit 10B of the present embodiment.

The acquisition unit 20A acquires the training data 40 including the second labeled training data 42B and the unlabeled training data 44 (Step S200).

The pseudo label estimation unit 22B determines whether the training data 40 to be processed among the training data 40 acquired by the acquisition unit 20A is the second labeled training data 42B to which the correct label 52 is assigned (Step S202).

When the training data 40 to be processed is the second labeled training data 42B to which the correct label 52 is assigned (Step S202: Yes), the pseudo label estimation unit 22B outputs the second labeled training data 42B to the learning unit 20C and the processing proceeds to Step S218 to be described later.

On the other hand, when the training data 40 to be processed is the unlabeled training data 44 to which the correct label 52 is not assigned (Step S202: No), the processing proceeds to Step S204.

In Step S204, the pseudo label estimation unit 20B specifies the first identification target region 62A, which is the face image region of the image 50 included in the unlabeled training data 44 (Step S204).

The pseudo label estimation unit 22B determines whether the face size specified from the face image region of the subject S specified in Step S204 is equal to or larger than a threshold value which is an estimatable condition (Step S206). That is, the pseudo label estimation unit 22B determines whether the state of the subject S represented by the identification target region 62 of the image 50 included in the unlabeled training data 44 satisfies the estimatable condition for estimating the attribute from the first identification target region 62A by the processing in Steps S204 to S206.

When the face size is equal to or larger than the threshold value (Step S206: Yes), the pseudo label estimation unit 22B determines that the gender can be estimated using the first identification target region 62A, which is the face image region of the image 50. Then, the processing proceeds to Step S208.

In Step S208, the pseudo label estimation unit 22B estimates the pseudo label 54A from the first identification target region 62A and the first learning model 30 (Step S208). The pseudo label estimation unit 22B inputs the face image region, which is the first identification target region 62A included in the image 50 of the unlabeled training data 44, to the first learning model 30. Then, the pseudo label estimation unit 22B acquires the attribute indicating the gender as an output from the first learning model 30. The pseudo label estimation unit 22B acquires the attribute output from the first learning model 30 to estimate the attribute as the pseudo label 54A.

Then, the pseudo label estimation unit 22B generates the first labeled training data 42A including a pair of the image 50 of the unlabeled training data 44 and the pseudo label 54A estimated in Step S208 (Step S212). Then, the processing proceeds to Step S218 to be described later.

On the other hand, when determining that the face size is less than the threshold value in Step S206 (Step S206: No), the pseudo label estimation unit 22B determines that it is difficult to estimate the gender using the first identification target region 62A, which is the face image region of the image 50. That is, in a case where the face size of the subject S is less than the threshold value, the pseudo label estimation unit 22B determines that the state of the subject S represented by the identification target region 62 of the image 50 does not satisfy the estimatable condition, and it is difficult to estimate the attribute using the first identification target region 62A in the image 50. Then, the processing proceeds to Step S214.

In Step S214, the pseudo label estimation unit 22B estimates the pseudo label 54B from the second identification target region 62B and the second learning model 32 (Step S214). The pseudo label estimation unit 22B inputs the whole body region, which is the second identification target region 62B included in the image 50 of the unlabeled training data 44, to the second learning model 32. Then, the pseudo label estimation unit 22B acquires the attribute indicating the gender as an output from the second learning model 32. The pseudo label estimation unit 22B acquires the attribute output from the second learning model 32 to estimate the attribute as the pseudo label 54B.

Then, the pseudo label estimation unit 22B generates the first labeled training data 42A including a pair of the image 50 of the unlabeled training data 44 and the pseudo label 54B estimated in Step S214 (Step S216). Then, the processing proceeds to Step S218.

In Step S218, the learning unit 20C learns the first learning model 30 by using the first identification target region 62A included in the training data 40 (Step S218).

The learning unit 20C receives, as the training data 40, the second labeled training data 42B determined in Step S202 (Step S202: Yes), the first labeled training data 42A generated in Step S212, and the first labeled training data 42A generated in Step S216. Then, the learning unit 20C specifies the first identification target region 62A, which the face image region from the image 50 included in the training data 40, and inputs the first identification target region 62A to the first learning model 30. Then, the learning unit 20C acquires the attribute 56, which is the gender output from the first learning model 30, by the input of the first identification target region 62A, as the attribute 56 estimated by the first learning model 30.

The output control unit 20D outputs the first learning model 30 learned in Step S218 (Step S220). Then, this routine is ended.

As described above, the pseudo label estimation unit 22B of the image processing apparatus 1B according to the present embodiment estimates the pseudo label 54 based on the identification target region 62 according to the type of the attribute to be identified by the first learning model 30 to be learned in the image 50 of the unlabeled training data 44, in the same manner as that of the pseudo label estimation unit 20B of the above embodiment. The learning unit 20C learns the first learning model 30 that identifies the attribute 56 of the image 50 by using the first labeled training data 42A obtained by assigning the pseudo label 54 to the image 50 of the unlabeled training data 44.

Therefore, the image processing apparatus 1B according to the present embodiment can provide the first learning model 30 (learning model) capable of identifying the attribute of the image 50 with high accuracy, in the same manner as that of the image processing apparatus 1 according to the above embodiment.

That is, the image processing apparatus 1B according to the present embodiment can provide the first learning model 30 capable of identifying the attribute with high accuracy for the first learning model 30 having the type of the attribute to be identified different from that of the image processing apparatus 1 according to the above embodiment.

It is noted that the image 50 included in at least one of the unlabeled training data 44, the first labeled training data 42A, and the second labeled training data 42B used in the first embodiment and the second embodiment is preferably an image of the same type as the input image to be processed of the first learning model 30. The input image to be processed of the first learning model 30 is an image used as a target to be input to the first learning model 30 in the information processing device as an application target destination of the first learning model 30.

The same type of the image 50 means that the properties of the elements included in the image 50 are the same between the image 50 and the input image.

Specifically, the image 50 having the same type means that at least one element of the photographing environment, the synthesis status, the processing status, and the generation status is the same.

For example, it is assumed that the input image input to the first learning model 30 at the application target destination is a synthetic image. In this case, the image 50 included in at least one of the unlabeled training data 44, the first labeled training data 42A, and the labeled training data 42B is preferably the synthetic image.

In addition, it is assumed that the input image input to the first learning model 30 at the application target destination is a photographed image photographed in a specific photographing environment. In this case, the image 50 included in at least one of the unlabeled training data 44, the first labeled training data 42A, and the second labeled training data 42B is preferably the photographed image photographed in the same specific photographing environment.

By using the same type of image as the input image as the image 50, deviation of an identification environment is reduced, and identification accuracy of the first learning model 30 can be further improved.

Next, an example of a hardware configuration of the image processing apparatus 1 and the image processing apparatus 1B according to the above embodiments will be described.

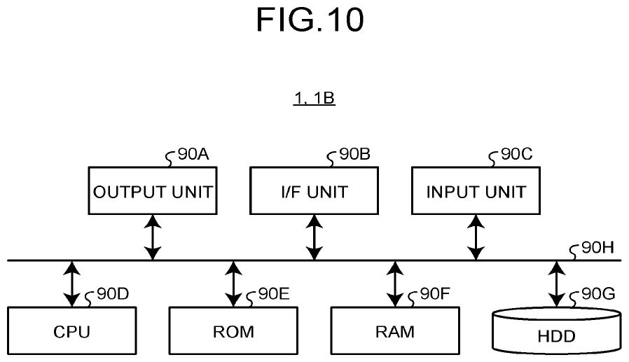

FIG. 10 is a hardware configuration diagram of an example of the image processing apparatus 1 and the image processing apparatus 1B according to the above embodiments.

The image processing apparatus 1 and the image processing apparatus 1B according to the above embodiments include a control device such as a central processing unit (CPU) 90D, a storage device such as a read only memory (ROM) 90E, a random access memory (RAM) 90F, and a hard disk drive (HDD) 90G, an I/F unit 90B that is an interface with various devices, an output unit 90A that outputs various types of information, an input unit 90C that receives an operation by a user, and a bus 90H that connects the respective units, and have a hardware configuration using a normal computer. In this case, the control unit 20 in FIG. 1 corresponds to a control device such as the CPU 90D.

In the image processing apparatus 1 and the image processing apparatus 1B according to the above embodiments, the CPU 90D reads a program from the ROM 90E onto the RAM 90F and executes the program, whereby the respective units are implemented on the computer.

It is noted that the program for executing each of pieces of the processing executed by the image processing apparatus 1 and the image processing apparatus 1B according to the above embodiments may be stored in the HDD 90G. In addition, the program for executing each of pieces of the processing executed by the image processing apparatus 1 and the image processing apparatus 1B according to the above embodiments may be provided by being incorporated in the ROM 90E in advance.

Furthermore, the program for executing the processing executed by the image processing apparatus 1 and the image processing apparatus 1B according to the above embodiments may be stored as a file in an installable format or an executable format in a computer-readable storage medium such as a CD-ROM, a CD-R, a memory card, a digital versatile disc (DVD), or a flexible disk (FD), and the same may be provided as a computer program product. In addition, the program for executing the processing executed by the image processing apparatus 1 and the image processing apparatus 1B according to the above embodiments may be stored on a computer connected to a network such as the Internet, and the same may be provided by being downloaded via the network. In addition, the program for executing the processing executed by the image processing apparatus 1 and the image processing apparatus 1B according to the above embodiments may be provided or distributed via a network such as the Internet.

It is noted that although the image processing apparatus 1 is configured with the image processing unit 10, the UI unit 14, and the communication unit 16 in the above description, the image processing apparatus according to the present invention may be configured with the image processing unit 10. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
one or more hardware processors configured to function as:
an acquisition unit configured to acquire unlabeled training data including an image to which a correct label of an attribute is not assigned;
a pseudo label estimation unit configured to estimate a pseudo label, which is an estimation result of the attribute of the image of the unlabeled training data, based on an identification target region according to a type of the attribute to be identified by a first learning model to be learned in the image of the unlabeled training data; and
a learning unit configured to learn the first learning model that identifies the attribute of the image using first labeled training data for which the pseudo label is assigned to the image of the unlabeled training data.

2. The image processing apparatus according to claim 1, wherein
the pseudo label estimation unit
estimates, when determining that it is difficult to estimate the attribute using a first identification target region, which is the identification target region used for learning of the first learning model, in the image of the unlabeled training data,
the pseudo label based on a second identification target region that is different from the first identification target region.

3. The image processing apparatus according to claim 2, wherein
the pseudo label estimation unit
estimates, when determining that the attribute is estimatable using the first identification target region in the image of the unlabeled training data,
the pseudo label based on the first identification target region.

4. The image processing apparatus according to claim 2, wherein
the pseudo label estimation unit
determines, when a state of a subject represented by the identification target region in the image of the unlabeled training data does not satisfy a predetermined estimatable condition for estimating the attribute from the first identification target region, that estimating the attribute using the first identification target region is difficult.

5. The image processing apparatus according to claim 2, wherein
the pseudo label estimation unit
estimates, when determining that it is difficult to estimate the attribute using the first identification target region in the image of the unlabeled training data, the pseudo label set in advance according to a state of a subject represented by the second identification target region.

6. The image processing apparatus according to claim 3, wherein
the pseudo label estimation unit
estimates, when determining that the attribute is estimatable using the first identification target region, the pseudo label from the first identification target region of the image of the unlabeled training data using a second learning model learned in advance.

7. The image processing apparatus according to claim 2, wherein
the pseudo label estimation unit
estimates, when determining that it is difficult to estimate the attribute using the first identification target region in the image of the unlabeled training data,
the pseudo label from the second identification target region of the image of the unlabeled training data using a second learning model learned in advance.

8. The image processing apparatus according to claim 3, wherein
the pseudo label estimation unit
estimates, when determining that the attribute is estimatable using the first identification target region in the image of the unlabeled training data,
the pseudo label from the first identification target region of the image of the unlabeled training data using the first learning model.

9. The image processing apparatus according to claim 6, wherein
the first learning model is a learning model having a processing speed higher than a processing speed of the second learning model.

10. The image processing apparatus according to claim 1, wherein
the acquisition unit
further acquires second labeled training data including an image to which the correct label is assigned, and
the learning unit
learns the first learning model by using the first labeled training data and the second labeled training data.

11. The image processing apparatus according to claim 10, wherein
the image included in at least one of the unlabeled training data, the first labeled training data, and the second labeled training data is an image of a same type as an input image to be processed of the first learning model.

12. An image processing method executed by a control unit including a hardware processor, the method comprising:
acquiring unlabeled training data including an image to which a correct label of an attribute is not assigned;
estimating a pseudo label, which is an estimation result of the attribute of the image of the unlabeled training data, based on an identification target region according to a type of the attribute to be identified by a first learning model to be learned in the image of the unlabeled training data; and
learning the first learning model that identifies the attribute of the image by using first labeled training data for which the pseudo label is assigned to the image of the unlabeled training data.

13. An image processing computer program product having a non-transitory computer readable medium including programmed instructions stored thereon, wherein the instructions, when executed by a computer, cause the computer to perform:
acquiring unlabeled training data including an image to which a correct label of an attribute is not assigned;
estimating a pseudo label, which is an estimation result of the attribute of the image of the unlabeled training data, based on an identification target region according to a type of the attribute to be identified by a first learning model to be learned in the image of the unlabeled training data; and
learning the first learning model that identifies the attribute of the image by using first labeled training data for which the pseudo label is assigned to the image of the unlabeled training data.
